(19) United States
(12) Patent Application Publication
(10) Pub. No.: US 2012/0073283 A1
(43) Pub. Date: Mar. 29, 2012

(54) HYDRAULIC CONTINUOUSLY VARIABLE TRANSMISSION STRUCTURE FOR AUTOMOBILE AND AUTOMOBILE HAVING THE SAME

(76) Inventor: Zhenfang WU, Hebei (CN)

(21) Appl. No.: 13/281,946

(22) Filed: Oct. 26, 2011

Related U.S. Application Data
(63) Continuation-in-part of application No. PCT/CN2009/073949, filed on Sep. 15, 2009.

(30) Foreign Application Priority Data
Apr. 28, 2009 (CN) 200920102510.4

(51) Int. Cl. F15B 13/00

(52) U.S. Cl. 60/484; 60/325

(57) ABSTRACT

The present invention provides a hydraulic continuously variable transmission structure for an automobile comprising an oil tank, a tee joint, a hydraulic pump, an automobile speed regulation valve, an astern valve and a hydraulic motor, wherein the oil tank, the hydraulic pump, the automobile speed regulation valve, the astern valve and the hydraulic motor are connected via oil pipes to form an integral hydraulic continuously variable transmission structure. An automobile adopting the hydraulic continuously variable transmission structure for an automobile is also provided. According to the present application, continuously variation of speed ratio may be achieved.

### RELATED APPLICATIONS

This application is a continuation-in-part of International Application No. PCT/CN2009/073949, filed Sep. 15, 2009 which claims priority of Chinese Patent Application No. 200920102510.4, filed Apr. 28, 2009, the disclosures of which are incorporated herein by reference.

### TECHNICAL FIELD OF THE INVENTION

The present invention relates to a hydraulic continuously variable transmission structure for an automobile and to an automobile having the same, and furthermore the present invention relates to a novel structure of hydraulic motor (hydraulic pump) matched with the hydraulic continuously variable transmission structure.

### BACKGROUND OF THE INVENTION

The operation of gear shifting by a driver may be eased by the use of a continuously variable transmission structure in an automobile.

In 1886, CVT (Continuously Variable Transmission) structure driven by a V-shaped rubber belt was firstly used in the low-emission automobiles by Germany Benz auto Co..

The continuously variable transmission structures currently used in the automobiles world-widely are substantially divided into the following three types:

Type 1: A structure formed by a gear transmission consisting of a hydraulic torque converter and an automatic gear shifter, which is widely used in most automobiles currently and in which the automatic gear shifter has been developed with eight gears from the initial three gears.

Type 2: CVT structure which is currently used in some automobiles;

Type 3: IVT (Infinitely Variable Transmission) structure which is currently used in a few automobiles.

The above mentioned three types of the continuously variable transmission structures have the common disadvantage as follows: none of them give up the use of the gear-drive gear, and further all of them have to equip with complicated hydraulic control systems.

It is a dream work to adopt genuine hydraulic continuously variable transmission structure in an automobile. However, since no hydraulic pump or hydraulic motor has been developed to be adapted to the high speed and high torque of automobiles, such a dream does not become true so far.

In the Chinese Patent No. ZL02281270.9 entitled “Hydraulic transmission device for automobile”, no hydraulic pump is developed for the high speed and high torque of automobiles and further a speed reducer has to be installed before a common hydraulic pump.

### SUMMARY OF THE INVENTION

It is an object of the present invention to provide a feasible hydraulic continuously variable transmission structure for an automobile which is simple-structured and is of higher transmission efficiency. To this end, a hydraulic vane pump and a hydraulic vane motor that are adaptive to the high speed and high torque of automobiles and known as WS-type structures are invented by the inventor and are applied to the present hydraulically driven continuously variable transmission structure. Since the additional installation of a speed reducer in front of a hydraulic pump is replaced by the direct connection of the WS-type hydraulic vane pump with the engine or clutch of an automobile, the continuously variable transmission structure according to the present application is simplified in structure and more efficiency.

In an embodiment of the present invention, there is provided a hydraulic continuously variable transmission structure for an automobile which comprises: an oil tank; a tee joint having three connecting ends; a hydraulic pump arranged behind an engine or a clutch, wherein the hydraulic pump is in communication with the oil tank and is connected to a first connecting end of the tee joint; an automobile speed regulation valve having one end connected to a second connecting end of the tee joint and the other end connected to the oil tank; an astern valve connected to a third connecting end of the tee joint and in communication with the oil tank; and a hydraulic motor connected with the astern valve and wheels, wherein the oil tank, the hydraulic pump, the automobile speed regulation valve, the astern valve and the hydraulic motor are connected via oil pipes to form an integral hydraulic continuously variable transmission structure.

Preferably, there is one, two or four hydraulic motors. In the case where there is only one hydraulic motor, the hydraulic motor is mounted before the differential; in the case where there are two hydraulic motors, the hydraulic motors are respectively mounted on two rear wheels or on two front wheels; and in the case where there are four hydraulic motors, the hydraulic motors are respectively connected with the four wheels comprising the two front wheels and the two rear wheels.

Preferably, the hydraulic motor is a WS-type vane motor, and the hydraulic pump is a WS-type vane pump. The WS-type vane motor (vane pump) comprises: a stator of a circular structure, a plurality of oil input/output ports are disposed on the outer circumference of the stator, a hydraulic oil distribution grooves are disposed on the inner circumference wherein the oil input/output ports are in communication with the hydraulic oil distribution groove, and wherein the ends of the distribution grooves extend respectively towards the inner circumference to form respective taper triangular relief grooves; and a rotor, blades are disposed thereon, wherein the rotor is provided with blade grooves cooperating with the blades and a spring is mounted at the bottom of each blade groove.

Preferably, the astern valve is a rotary core type two-position four-way valve or translation type two-position four-way valve.

The present invention also provides an automobile which adopts the hydraulic continuously variable transmission structure for an automobile above mentioned.

### BRIEF DESCRIPTION OF THE DRAWINGS

The accompanying drawings illustrated herein which form a part of this disclosure are provided for a better understanding of the present invention, and the exemplary embodiments of the present invention and the description thereof are used for explaining the invention but not for limiting the invention. In the accompanying drawings:

FIG. 1 is a schematic diagram showing an embodiment of the hydraulic continuously variable transmission structure for an automobile according to the present invention;

FIG. 2 is a schematic diagram showing the structure of an embodiment of the WS-type vane motor and the WS-type vane pump applied to the hydraulic continuously variable transmission structure for an automobile according to the present invention;

FIG. 3 is a schematic diagram showing a hydraulic continuously variable transmission structure using one hydraulic motor;

FIG. 4 is a schematic diagram showing a hydraulic continuously variable transmission structure using four hydraulic motors; and

FIG. 5 is a schematic diagram showing a hydraulic continuously variable transmission structure enabling both front wheels and rear wheels to reverse synchronously.

### DETAILED DESCRIPTION OF THE EMBODIMENTS

The present invention will be described below in detail with reference to the accompanying drawings in conjunction with embodiments.

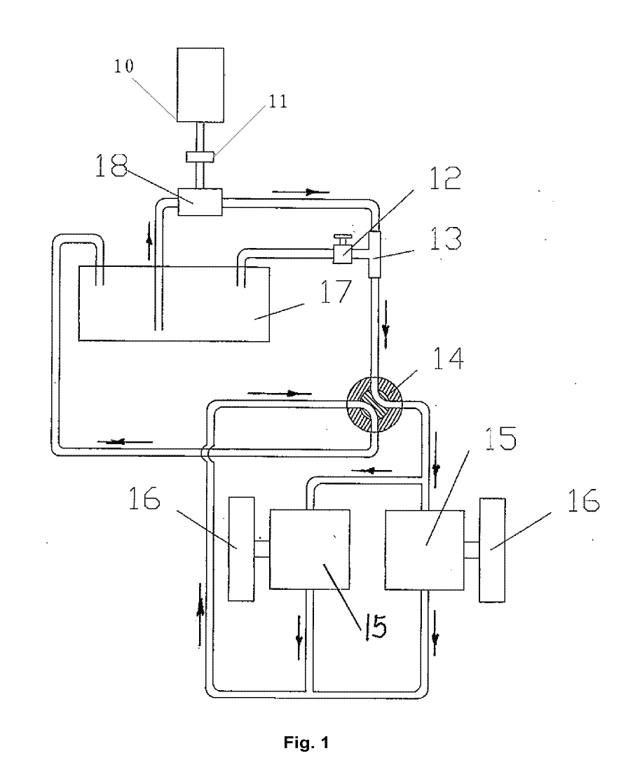

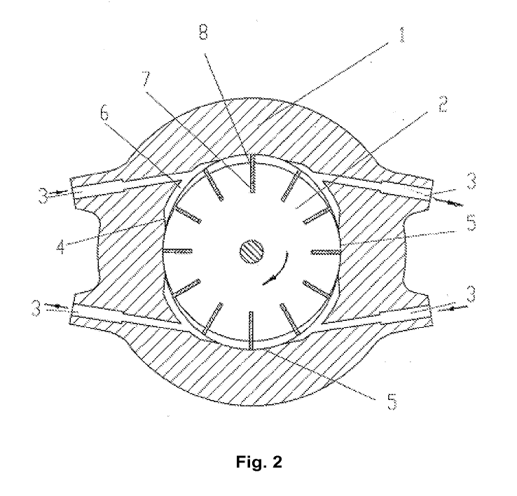

FIG. 1 is a schematic diagram showing the structure of an embodiment of the hydraulic continuously variable transmission structure for an automobile according to the present invention. Referring to FIG. 1 in conjunction with FIG. 2-FIG. 5, as shown in the figures, in an embodiment of the present invention, there is provided a hydraulic continuously variable transmission structure for an automobile which comprises: an oil tank 17; a tee joint 13 having three connecting ends; a hydraulic pump 18 arranged behind an engine 10 or a clutch 11, wherein the hydraulic pump 18 is in fluid communication with the oil tank 17 and is connected to a first connecting end of the tee joint 13; an automobile speed regulation valve 12 having one end connected to a second connecting end of the tee joint 13 and the other end connected with the oil tank 17; an astern valve 14 connected to a third connecting end of the tee joint 13 and in communication with the oil tank 17; and a hydraulic motor 15 connected with the astern valve 14 and the wheels, wherein the oil tank 17, the hydraulic pump 18, the automobile speed regulation valve 12, the astern valve 14 and the hydraulic motor 15 are connected via oil pipes to form an integral hydraulic continuously variable transmission structure, wherein the rod of the automobile speed regulation valve is connected with an accelerator (throttle) regulator of the automobile to realize a synchronous regulation. The hydraulic motor is connected with the wheels 16. The hydraulic motor is a WS-type vane motor, and the hydraulic pump is a WS-type vane pump, which will be described in detail later.

Preferably, there may be one, two or four hydraulic motors 15. In the case where there is only one hydraulic motor 15, the hydraulic motor 15 is mounted before the differential; in the case where there are two hydraulic motors 15, the hydraulic motors 15 are respectively mounted on two rear wheels or on two front wheels; and in the case where there are four hydraulic motors 15, the hydraulic motors 15 are respectively connected with the two front wheels and the two rear wheels, Herein it is possible to mount one hydraulic motor 15 before the differential, and the hydraulic motor drives the wheels through the differential so as to rotate the wheels. It is possible to mount two hydraulic motors on the two rear wheels or on the two front wheels, forming the rear wheel drive or the front wheel drive. It is possible to mount four hydraulic motors respectively on the four wheels (the two front wheels and the two rear wheels), forming four-wheel drive.

The operation principle of the hydraulic continuously variable transmission structure for an automobile according to the present application is as follows: the torque generated by the engine 10 is transmitted to the hydraulic pump 18 directly or via the clutch 11, the hydraulic pump 18 produces high pressure oil, the oil feeding pipe is connected with the tee joint 13, one end of the tee joint 13 is connected with the hydraulic motor 15 via the astern valve 14, and the output shaft of the hydraulic motor drives wheels to rotate. Another end of the tee joint 13 is mounted with the automobile speed regulation valve 12 capable of regulating the amount of the oil flowing into the hydraulic motor. When it is needed to decrease the automobile speed, the automobile speed regulation valve 12 is slowly opened, the high pressure oil flowing to the hydraulic motor is relatively reduced since a part of the high pressure oil can flow directly into the oil tank 17, and thus the rotation speed of the hydraulic motor is accordingly slowed down. And conversely, acceleration can be realized. Therefore, a continuously variable transmission can be achieved by only adjusting the opening degree of the automobile speed regulation valve. By rotating the valve core of the astern valve 14 (four-way valve) by 90 degrees, the position where the high pressure oil flows into the hydraulic motor 15 can be varied, that is, the rotation direction of the hydraulic motor 15 can be varied, thereby the travel direction of the automobile can be varied.

As shown in FIG. 2, the hydraulic motor 15 is preferably a WS-type vane motor, and the hydraulic pump 18 is preferably a WS-type vane pump. Preferably, the hydraulic motor 15 and the hydraulic pump 18 have identical structure and both of them comprises: a stator 1 having hydraulic oil distribution grooves 6 provided thereon, wherein the ends of the distribution grooves 6 extend respectively towards the inner circumference 5 to form respective taper triangular relief grooves 4, four hydraulic oil input/output ports 3 are disposed on the outer circumference of the stator, and the oil input/output ports 3 are in communication with the respective hydraulic oil distributing grooves 6; and a rotor 2, on which blades 8 are disposed, wherein the rotor 2 is provided with blade grooves in cooperation with the blades 8 and a spring 7 is mounted at the bottom of each blade groove.

The astern valve 14 is a rotary core type two-position four-way valve or a translation type two-position four-way valve.

More specifically, the vane motor 15 (the vane pump 18) comprises a stator 1 of circular structure and a rotor 2 provided with blades 8, wherein blade grooves are provided on the rotor 2 so as to cooperate with the blades 8, a spring 7 is mounted on the bottom of each blade groove, and the blades 8 can slide along the blade grooves in a radial direction. Under the action of the springs 7, the top surface of each blade 8 is always in contact with the inner curved surface of the stator 1, thus the leakage of the high pressure oil to a low-pressure region is decreased. The transitional inner circumference 5 of the stator 1 is manufactured with wide and deep hydraulic oil distribution grooves 6, the ends of which extend respectively towards the inner circumference 5 so as to form taper triangular relief grooves 4. Four hydraulic oil input/output ports 3 are distributed on the outer circumference of the stator 1, and the oil channels of the four hydraulic oil input/output ports 3 are in communication with the hydraulic oil distribution grooves 6. In this way, the high pressure oil, after entering the inner curved surface of the stator 1, can be rapidly distributed between the blades 8 in a high-pressure region, so as to produce the maximum stable combined push force for the blades. Due to such formed relief grooves 4, no oil trapping or oil pulsation phenomena occur in the WS-type vane motor 15 and the WS-type vane pump 18 of the present structure. By varying the dimensional sizes of the rotator 2 and the stator 1, vane motors 15 and the vane pump 18 suitable for automobiles of various powers and rotation speeds can be designed.

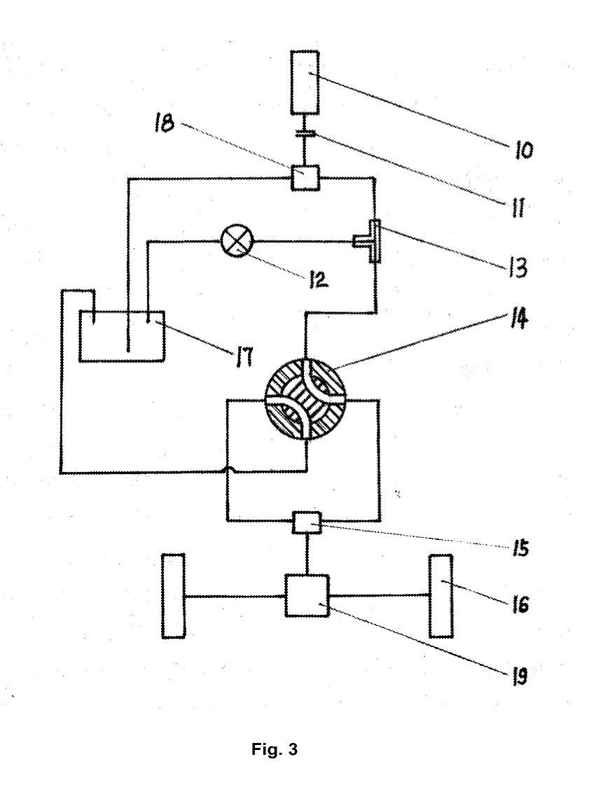

As shown in FIG. 3, the torque generated by the engine 10 of the automobile drives, via the clutch 11, the hydraulic pump 18 to rotate, the high pressure oil produced by the hydraulic pump flows into the hydraulic vane motor 15 via the tee joint 13 and the astern valve 14 so as to urge the hydraulic vane motor 15 to rotate. The output shaft of the hydraulic motor is connected with the differential of the automobile so as to drive the differential to rotate. The two semi-axles of the differential respectively drive the right wheels and the left wheels of the automobile to rotate so as to produce power. The rotation speed of the hydraulic motor, i.e. the travel speed of the automobile, can be regulated by regulating the opening degree of the automobile speed regulation valve 12. By rotating the core of the astern valve 14 by 90 degrees, the position where the high pressure oil flows into the hydraulic motor can be varied so as to vary the rotation direction of the hydraulic motor, that is, to vary the travel direction (forward or backward) of the automobile.

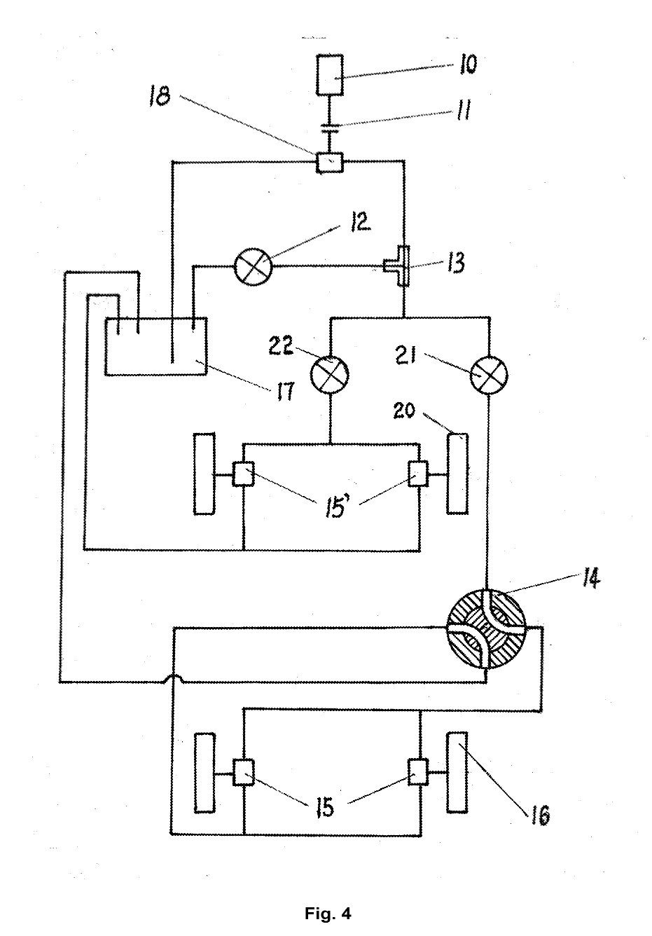

As shown in FIG. 4, the torque generated by the engine 10 drives, via the clutch 11, the hydraulic pump 18 to rotate, the high pressure oil produced by the hydraulic pump is , via the tee joint 3, respectively in communication with a front wheel driving and controlling valve 22 and a rear wheel driving and controlling valve 21 of the automobile, wherein the front wheel controlling valve 22 is connected with a front wheel driving hydraulic motor 15′, and the rear wheel controlling valve 21 is connected with a rear wheel driving hydraulic motor 15 via the astern valve 14. The automobile speed regulation valve 12 is connected with the tee joint 13. The front wheels and rear wheels will be driven simultaneously if the controlling valves 21 and 22 are simultaneously opened. A rear-wheel drive is achieved when the front wheel controlling valve 22 is closed. A front-wheel drive is achieved when the front wheel controlling valve 22 is opened and the rear wheel controlling valve 21 is closed. A reverse (backing the automobile) can be achieved by closing the front wheel controlling valve 22, opening the rear wheel controlling valve 21 and rotating the core of the astern valve 14 by 90 degrees. The speed regulation of the automobile can be achieved by regulating suitably the opening speed of the automobile speed regulation valve 12.

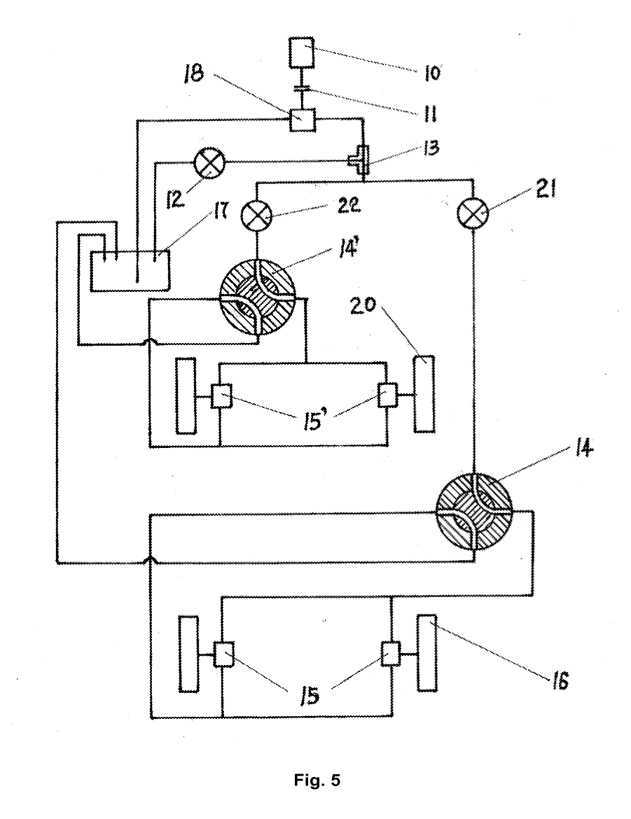

The structure shown in FIG. 5 is obtained by additionally providing an astern valve 14′ behind the front wheel driving and controlling valve 22 on the basis of the structure shown in FIG. 4. The rear wheel astern valve 14 and the front wheel astern valve 14′ can be synchronously regulated by a controller element, so as to enable the front wheels and rear wheels to move backward simultaneously when a greater power is needed to achieve a reverse. Other functions of this structure are similar to those of the structure given in FIG. 4.

The present invention also provides an automobile which adopts the hydraulic continuously variable transmission structure for an automobile above mentioned.

It can be seen from the description above that the present invention achieves the following technical effects:

In the hydraulic continuously variable transmission structure for an automobile according to the present application, the oil tank, the hydraulic pump, the automobile speed regulation valve, the astern valve and the hydraulic motor are connected via oil pipes to form an integral structure. Such structure replaces the gear-drive pair existed in the currently continuously variable transmission structures with high-efficiency WS-type hydraulic vane pump and hydraulic vane motor and is therefore higher in transmission efficiency. The continuously variable transmission structure according to the present invention, with simple structure, high transmission efficiency and stable transmission performance, will become an important milestone in the history of the development of automobiles and it will be the optimal selection for the automobile manufacturers. The age of the genuine hydraulic continuously variable transmission structure for an automobile will come soon.

The above description is only for the preferred embodiments of the invention rather than making any limitation thereto. Various modification and variations may be devised by those skilled in the art. It should be understood that any modification, equivalent and improvement devised within the spirit and the scope of the invention belong to the protection scope of the invention.

What is claimed is:

1. A hydraulic continuously variable transmission structure for an automobile, comprising:
an oil tank (17);
a tee joint (13) having three connecting ends;
a hydraulic pump (18), which is arranged behind an engine (10) or a clutch (11), wherein the hydraulic pump (18) is in communication with the oil tank (17) and is connected to a first connecting end of the tee joint (13);
an automobile speed regulation valve (12) having one end connected to a second connecting end of the tee joint (13) and the other end connected with the oil tank (17);
an astern valve (14) connected to a third connecting end of the tee joint (13) and in communication with the oil tank (17); and
a hydraulic motor (15) connected with the astern valve (14) and wheels (16),
wherein the oil tank (17), the hydraulic pump (18), the automobile speed regulation valve (12), the astern valve (14) and the hydraulic motor (15) are connected via oil pipes to form an integral hydraulic continuously variable transmission structure.

2. The hydraulic continuously variable transmission structure for an automobile according to claim 1, wherein there is one, two or four hydraulic motors (15), wherein in the case where there is one hydraulic motor (15), the hydraulic motor (15) is mounted before the differential; in the case where there are two hydraulic motors (15), the hydraulic motors (15) are respectively mounted on two rear wheels or on two front wheels, and in the case where there are four hydraulic motors (15), the hydraulic motors (15) are respectively connected to the four wheels comprising the two front wheels and the two rear wheels.

3. The hydraulic continuously variable transmission structure for an automobile according to claim 1, wherein the hydraulic motor (15) and the hydraulic pump (18) have identical structures and each of them comprises:
a stator (1) of a circular structure, a plurality of oil input/output ports (3) are disposed on the outer circumference of the stator, hydraulic oil distribution grooves (6) are disposed on the inner circumference (5) of the stator, wherein the oil input/output ports (3) are in communication with the respective hydraulic oil distribution grooves (6), and wherein the ends of the distribution grooves (6) extend towards the inner circumference (5) so as to form a taper triangular relief groove (4); and
a rotor (2) having blades (8) disposed thereon, wherein the rotor (2) is provided with blade grooves cooperating with the blades (8) and a spring (7) is mounted at the bottom of each blade groove.

4. The hydraulic continuously variable transmission structure for an automobile according to claim 1, wherein the astern valve (14) is a rotary core type two-position four-way valve or a translation type two-position four-way valve.

5. An automobile adopting the hydraulic continuously variable transmission structure for an automobile according to claim 1.
